(19) United States
(12) Patent Application Publication
(10) Pub. No.: US 2010/0061726 A1
(43) Pub. Date: Mar. 11, 2010

(54) Dynamically Reconfiguring An Optical Network Using An Ethernet Switch

(76) Inventors: Giovanni Barbarossa, Saratoga, CA (US); Xiaodong Duan, Pleasanton, CA (US); Samuel Liu, San Jose, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/207,450

(22) Filed: Sep. 9, 2008

(51) Int. Cl. H04J 14/00

(52) U.S. Cl. 398/48

(57) ABSTRACT

An Ethernet switch is used to dynamically reconfigure an optical network having a fixed optical layer. The Ethernet switch is incorporated into a transmission node of the optical network to selectively route data streams received through its input channels to one of the output channels. The data streams at the output channels are multiplexed into multiple wavelength channels of a multiplexed optical signal, and the wavelength channels are selectively dropped at local nodes of the optical network. In addition, the Ethernet switch can be used to reroute data from a single data stream to multiple wavelength channels, and thereby perform sub-wavelength multiplexing.

### BACKGROUND OF THE INVENTION

1. Field of the Invention

Embodiments of the present invention relate generally to optical communication systems and, more particularly, to dynamically reconfiguring an optical network using an Ethernet switch.

2. Description of the Related Art

Optical networks are used extensively in telecommunications for voice and other applications. As utilization of optical communication networks increases, there is an ongoing effort to lower the cost of such networks. Wavelength division multiplexing (WDM) is one approach for lowering the per-channel cost of an optical network.

In a WDM optical communication system, information is carried by multiple channels, each channel corresponding to a unique wavelength. WDM allows transmission of data from different sources over the same fiber optic link simultaneously, since each data source is assigned a dedicated channel. The result is an optical communication link with an aggregate bandwidth that increases with the number of wavelengths, i.e., wavelength channels, incorporated into the WDM signal. In this way, WDM technology maximizes the use of an available fiber optic infrastructure; what would normally require multiple optic links or fibers instead requires only one.

In WDM optical communication systems, it is often necessary to add and/or drop a wavelength channel at a network node. One approach in the art for performing an add/drop operation on a WDM signal at a network node is by means of an optical switching device, such as a reconfigurable optical add/drop multiplexer (ROADM). A ROADM is configured to switch traffic in an optical network at the optical layer, thereby allowing individual wavelengths carrying data channels to be added and dropped from a transport fiber at a network node without the need to convert the optical signals to electronic signals and back again to optical signals. Hence, the optical layer of a communications system configured with ROADMs can be easily reconfigured both remotely and at any time.

A drawback of using ROADMs is cost, especially for optical access networks, where higher-cost components, such as ROADMs, are not cost effective when compared to less sophisticated optical add-drop multiplexers (OADMs). OADMs are optical switching devices that drop and/or add a fixed wavelength channel and cannot be reconfigured for different wavelength channels. In addition, the transfer of data between wavelength channels, i.e., the routing of portions of the data contained in multiple wavelength channels to a single node, is not possible when all data in a given wavelength channel is optically routed to an individual node, as with a ROADM-based configuration.

Another approach in the art for performing an add/drop operation on a WDM signal at a node is optical-to-electronic-to-optical (OEO) conversion. In OEO, all incoming wavelength channels are demultiplexed, converted to electronic signals, and routed as desired, e.g., dropped at or passed through the node. Signals passing through the node are then converted back to optical signals, multiplexed with any optical signals that have been added locally, and transmitted to other network nodes. As with the ROADM-based approach, a disadvantage of using OEO is cost. Although a majority of wavelength channels directed to a node only need to pass through the node, OEO requires transponders at each node to convert all channels to electronic signals and then back to optical signals. In addition, OEO results in higher power consumption at each node and in some cases greater space requirements for the node.

Accordingly, there is a need for a method to dynamically drop and/or add optical signals in an optical network at a reduced cost over prior art methods, and that allows the reordering of data between wavelength channels.

### SUMMARY OF THE INVENTION

Embodiments of the present invention provide systems and methods for dynamically reconfiguring an optical network using an Ethernet switch, so as to selectively route Ethernet-based data traffic received at the Ethernet switch to local nodes in the optical network.

According to an embodiment of the invention, a reconfigurable optical communication system comprises an Ethernet switch having multiple input and output channels, an optical transceiver coupled to the Ethernet switch and configured to generate a multiplexed optical signal from signals received from the output channels of the Ethernet switch, and an optical unit coupled to the optical transceiver to receive the multiplexed optical signal and configured to drop a wavelength channel. The Ethernet switch is configured to direct a data stream received over each of the input channels to one of the output channels based on data extracted from the data stream, which may be VLAN tags stored in the headers of Ethernet data packets that make up the data stream.

A method for routing an Ethernet-based data stream to one of first and second nodes of an optical network, according to an embodiment of the invention, comprises the steps of receiving multiple data streams of Ethernet packets through input channels of an Ethernet switch, the multiple data streams including at least a first data stream and a second data stream, directing the first data stream to a first output channel of the Ethernet switch based on data contained in the first data stream, directing the second data stream to a second output channel of the Ethernet switch based on data contained in the second data stream, generating a multiplexed optical signal that includes at least the first data stream in a first wavelength channel and the second data stream in a second wavelength channel, and receiving the multiplexed optical signal at the first node and outputting one of the first and second data streams at the first node by dropping one of the first and second wavelength channels at the first node.

A method for generating a multiplexed optical signal from data streams of Ethernet packets, according to an embodiment of the invention, comprises the steps of examining header data of each Ethernet packet, directing the Ethernet packet to a first optical transceiver input channel if header data is of a first type and to a second optical transceiver input channel if header data is of a second type, and multiplexing Ethernet packets received through optical transceiver input channels including the first optical transceiver input channel and the second optical transceiver input channel to generate a multiplexed optical signal, wherein each of the optical transceiver input channels correspond to a different wavelength channel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a partial block diagram of an optical network, according to an embodiment of the invention.

FIG. 2 schematically illustrates sub-wavelength multiplexing of data traffic in a transmission node for distribution to an optical network, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate using an Ethernet switch to dynamically reconfigure an optical network so as to selectively direct the Ethernet-based data traffic to local nodes in the optical network. The Ethernet switch, also referred to as a Layer 2 or L-2 switch, is incorporated in a transmission node of an optical network having a fixed optical layer. The transmission node, when so configured, selectively routes Ethernet-based data traffic to local network nodes. In this way, the Ethernet switch circumvents the need for using reconfigurable optical add/drop multiplexing (ROADM) or optical-to-electronic-to-optical (OEO) conversion at each node, thereby allowing the use of a fixed optical layer. Thus, only an OADM is needed at each node in the optical network to route Ethernet traffic signals to a desired node in the network. In addition, the Ethernet switch can reroute data from a data stream to multiple wavelength channels, i.e., perform sub-wavelength multiplexing.

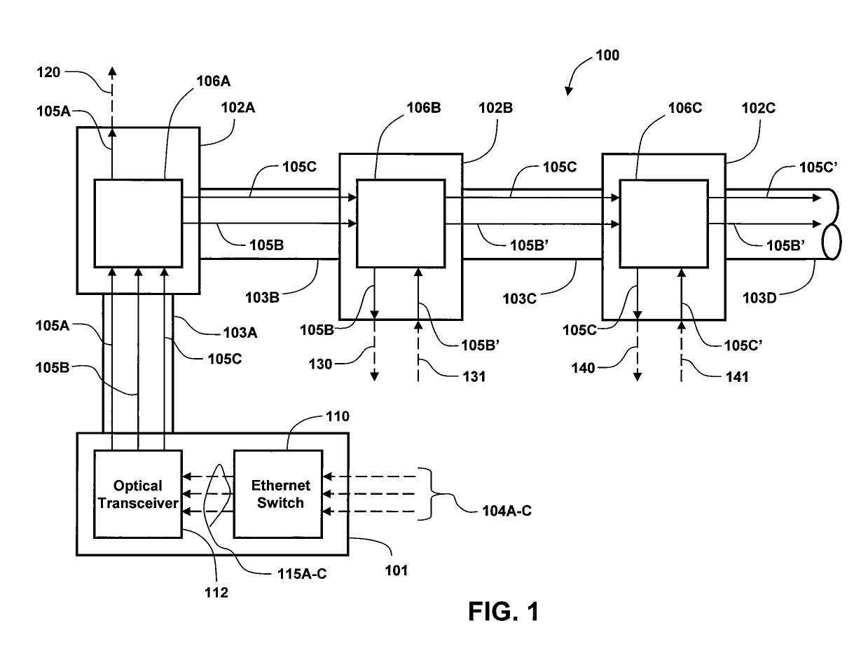

FIG. 1 illustrates a partial block diagram of an optical network 100, according to an embodiment of the invention. Dashed arrows, e.g., 104A-C, represent pathways of electrical or electronic signals, and solid arrows, e.g., 105A-C, represent optical signals. Optical network 100 is an Ethernet-based network, where the signal traffic carried thereby is organized in data frames, or “packets,” according to an Ethernet protocol, such as 1 Gigabit Ethernet (GbE) or 10 GbE, as defined by IEEE 802.3-2005. Optical network 100 includes local nodes 102A-C, a transmission node 101, and a plurality of optical fibers 103A-D that optically couple optical network 100 and local nodes 102A-C, as shown. Optical fibers 103A-D act as optical media for a plurality of optical signals 105A-C, where each of optical signals 105A-C is an individual wavelength channel containing a data stream of Ethernet packets dedicated for delivery to a particular local node. For example, in one configuration of optical network 100, local node 102A is configured to receive optical signal 105A, local node 102B is configured to receive optical signal 105B, and local node 102C is configured to receive optical signal 105C.

One skilled in the art will understand that optical network 100 may be configured as a transmission ring with additional local nodes located further downstream from 102C. In such a configuration, transmission node 101 may also be optically coupled to the last local node in the transmission ring. It is also understood that optical components of optical communication networks are typically bidirectional in nature, and therefore may distribute optical signals in both directions, i.e., from the local nodes to a transmission node, and vice-versa. For clarity, the operation of optical network 100 is described using unidirectional optical paths.

In operation, optical network 100 is configured to receive a plurality of electronic signals, each containing a data stream of Ethernet packets. Optical network 100 then sorts the Ethernet packets from the data streams, and converts them into a single multiplexed optical signal. The multiplexed optical signal is transmitted to the local nodes of optical network 100. For clarity, optical network 100 is described herein as receiving three data streams and routing these data streams to three local nodes, i.e., local nodes 102A-C, via three optical signals, i.e., optical signals 105A-C. However, it is contemplated that optical network 100 may include larger numbers of data streams, optical signals, and local nodes, e.g. up to 50 or more of each.

Transmission node 101 includes an Ethernet switch 110, and an optical transceiver 112, and receives electrical input signals 104A-C at Ethernet switch 110. Ethernet switch 110 is configured to receive multiple Ethernet data streams, i.e., electrical input signals 104A-C, via a non-optical medium, such as a twisted pair networking cable or an unshielded twisted pair (UTP). Each of electrical input signals 104A-C contains a data stream made up of a series of GbE packets, where each data stream is designated for delivery to one of the local nodes of optical network 100, i.e., local node 102A, 102B, 102C, or another local node not illustrated in FIG. 1.

After receiving electrical input signals 104A-C, Ethernet switch 110 sorts the data streams contained in each of electrical input signals 104A-C to one of electrical output signals 115A-C. For example, the data stream contained in electrical input signal 104A is routed to electrical output signal 115B, the data stream contained in electrical input signal 104B is routed to electrical output signal 115C, and the data stream contained in electrical input signal 104C is routed to electrical output signal 115A. However, it is understood that the data streams contained in electrical input signals 104A-C may be sorted differently between electrical output signals 115A-C by Ethernet switch 110. In this way, the ultimate destination node in optical network 100 for the data stream contained in each of electrical input signals 104A-C is selected by Ethernet switch 110 prior to conversion of the data stream into an optical channel by optical transceiver 112.

In one embodiment, Ethernet switch 110 sorts the data streams contained in electrical input signals 104A-C based on the VLAN tag assignment of each packet contained therein. In this embodiment, the header of each Ethernet data packet contained in electrical input signals 104A-C includes a virtual LAN (VLAN) tag providing destination node information for the packet. Thus, to change the destination node for one of electrical input signals 104A-C, the VLAN tag for each packet in the signal is updated accordingly before the signal is received by transmission node 101. For example, an Ethernet switch that is outside of optical network 100 and configured to transmit electrical input signal 104A to Ethernet switch 110 may perform the VLAN tag reassignment when the destination node for electrical input signal 104A is changed. Similarly, the VLAN tag reassignment for changing the destination node for electrical input signals 104B and 104C may also be performed by Ethernet switches outside of optical network 100.

Optical transceiver 112 receives electrical output signals 115A-C, converts each electrical signal to a corresponding optical signal, i.e., one of optical signals 105A-C, and multiplexes the optical signals into a single light beam. As noted above, each of optical signals 105A-C is a unique wavelength channel, and therefore can be multiplexed into a single light beam. Because Ethernet switch 110 sorts the packets of each data stream from electrical input signals 104A-C between electrical output signals 115A-C as desired, the wavelength channel, i.e., optical signal 105A, 105B, or 105C, associated with each electrical input signal 104A, 104B, or 104C is not fixed. Optical transceiver 112 then transmits the light beam containing optical signals 105A-C to local node 102A via optical fiber 103A. For illustrative purposes, optical signals 105A-C are depicted schematically as three individual optical signals, but are actually contained in a single light beam.

In the embodiment of the optical network illustrated in FIG. 1, local node 102A is configured as a drop-only node for optical signal 105A and includes an OADM 106A to perform the wavelength channel drop operation. Hence, local node 102A can only receive and drop a single, fixed wavelength channel, i.e., optical signal 105A. However, optical network 100 can still be dynamically reconfigured to direct the data stream from any of electrical input signals 104A-C to local node 102A. To that end, Ethernet switch 110 dynamically reconfigures optical network 100 by directing the data stream from any of electrical input signals 104A-C to optical signal 105A as described above. Unlike a ROADM or other reconfigurable optical switching device that receives a desired data stream at a local node by optically reconfiguring which wavelength channel is received by the local node, OADM 106A can only drop a fixed wavelength channel, i.e., optical signal 105A, and cannot be reconfigured for different wavelength channels.

Local node 102A converts optical signal 105A to a dropped signal 120, which is an electronic signal used at local node 102A. Dropped signal 120 contains the data stream associated with electrical input signal 104A, 104B, or 104C, depending on the current configuration of optical network 100. Local node 102A is further configured to optically process optical signals 105B and 105C as optical express channels, i.e., to transmit optical signals 105B and 105C via optical fiber 103B to “downstream” network nodes, such as local nodes 102B, 102C, etc. Optical express channels are wavelength channels that are not designated for use at a particular local node and are optically transmitted through the node. Because local node 102A is configured with OADM 106A and is therefore optically fixed, local node 102A cannot be reconfigured to drop optical signal 105B or 105C, or to treat optical signal 105A as an optical express channel.

Local node 102B is configured as an add-drop node and includes an OADM 106B to perform the wavelength channel add-drop operation. OADM 106B is configured to select optical signal 105B as the dropped wavelength channel, transmit an optical signal 105B′ as the added wavelength channel, and receive and transmit optical signal 105C as an optical express channel. Local node 102B converts optical signal 105B to a dropped signal 130, which is an electronic signal used at local node 102B. Similar to dropped signal 120, dropped signal 130 contains the data stream associated with electrical input signal 104A, 104B, or 104C, depending on the current configuration of optical network 100. In addition, local node 102B converts an added electrical signal 131 to optical signal 105B′, which OADM 106B multiplexes with optical signal 105C and transmits via optical fiber 103C to downstream local nodes.

Similar to local node 102A, local node 102B is configured with an OADM and is optically fixed. Therefore, local node 102B cannot be reconfigured to drop optical signal 105C or to treat optical signal 105B as an optical express channel. But because the data stream content of each of optical signals 105A-C is dynamically reconfigurable at Ethernet switch 110, the data stream directed to local node 102B is also dynamically reconfigurable, despite the fixed nature of the optical layer of network 100.

Local node 102C is substantially similar in organization and operation to local node 102B. To with, local node 102C is configured as an add-drop node and includes an OADM 106C configured to select optical signal 105C as the dropped wavelength channel, transmit an optical signal 105C′ as the added wavelength channel, and receive and transmit optical signal 105B′ as an optical express channel. Local node 102C converts optical signal 105C to a dropped signal 140, which is an electronic signal used at local node 102C. Local node 102C also converts an added electrical signal 141 to optical signal 105C′, which OADM 106C multiplexes with optical signal 105B′ and transmits via optical fiber 103D to downstream local nodes. And, like local nodes 102A and 102B, local node 102C is configured with an OADM and is therefore optically fixed.

In sum, optical network 100 is an optical network that has a fixed optical layer and is configured to selectively route each of a plurality of GbE data streams to local nodes of the network. Because each data stream carried by optical network 100 is sorted to the desired wavelength channel prior to conversion into an optical signal, the network can dynamically reconfigure the destination node for each data stream. Hence, optical network 100 possesses the flexibility of a reconfigurable optical network while using only relatively inexpensive OADMs at each node. It is understood that different combinations of drop-only and add/drop nodes than the combination illustrated in FIG. 1 are also contemplated by embodiments of the invention.

In one embodiment, it is contemplated that information received by transmission node 101 via electrical input signals 104A-C can be sorted to each local node of optical network 100 on the individual data packet level, using a process referred to as “sub-wavelength multiplexing.” Consequently, all data packets contained in a given data stream are not directed to a single local node and instead are selectively distributed to multiple local nodes of the optical network as desired. For example, a first portion of the data stream contained in electrical input signal 104A may be directed to local node 102A, a second portion of the data stream to local node 102B, and a third portion of the data stream to local node 102C. Thus, it is not necessary to route the entire data stream contained in electrical input signal 104A to a single local node in optical network 100, the entire data stream contained in electrical input signal 104B to another local node, etc. It is noted that sub-wavelength multiplexing, as described herein, is not possible when data traffic in an optical network is reconfigured using optical switching devices, such as ROADMs, incorporated into each node of the network.

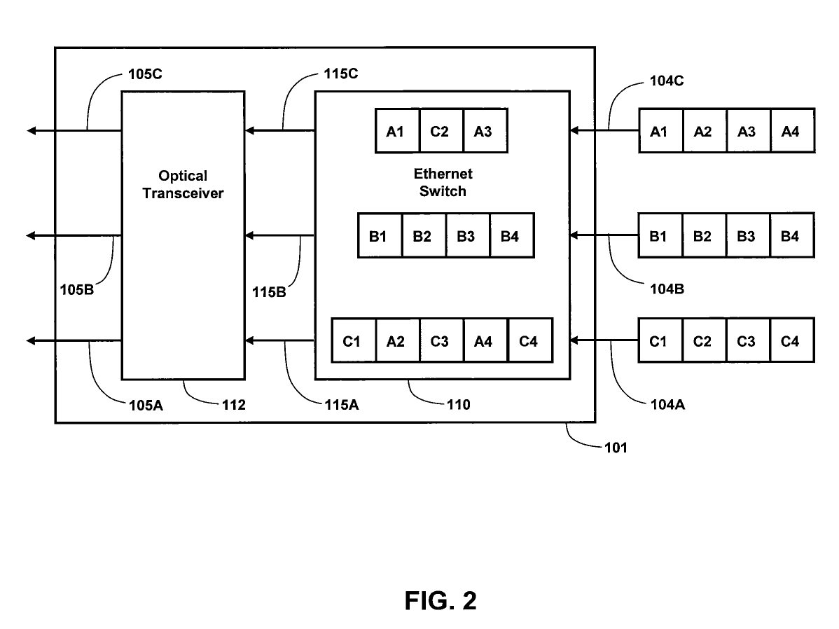

FIG. 2 schematically illustrates sub-wavelength multiplexing of data traffic in transmission node 101 for distribution to optical network 100, according to an embodiment of the invention. As described above in conjunction with FIG. 1 and illustrated in FIG. 2, Ethernet switch 110 receives electrical input signals 104A-C, where each of electrical input signals 104A-C contains a data stream made up of a series of GbE packets. In this embodiment, all packets contained in a given data stream are not routed to a single local node of optical network 100, but instead are distributed between multiple local nodes.

By way of illustration, electrical input signal 104A includes packets A1-A4, electrical input signal 104B includes packets B1-B4, and electrical input signal 104C includes packets C1-C4. Ethernet switch 110 receives and sorts each packet based on destination node information for the packet contained in the packet header, such as a VLAN tag. Sorting of packets A1-A4, B1-B4, and C1-C4 by Ethernet switch 110 to electrical output signals 115A-C enables the routing of data from multiple data streams to a single node of optical network 100. In the embodiment illustrated in FIG. 2, Ethernet switch 110 sorts packets A1, C2, and A3 together and transmits said packets as electrical output signal 115A to optical transceiver 112 for conversion into optical signal 105A. Similarly, Ethernet switch 110 sorts packets B1-B4 together and transmits these packets as electrical output signal 115B to optical transceiver 112 for conversion into optical signal 105B. Lastly, Ethernet switch 110 sorts packets C1, A2, C3, A4, and C4 together and transmits these packets as electrical output signal 115C to optical transceiver 112 for conversion into optical signal 105C. In this way, packets from multiple electrical input signals, e.g., electrical input signals 104A and 104C, are combined into a single wavelength channel, e.g., optical signal 105A, for transmission to a local node of optical network 100, thereby providing an additional level of flexibility in the configuration of the network.

While the foregoing is directed to embodiments of the present invention, other and further embodiments of the invention may be devised without departing from the basic scope thereof, and the scope thereof is determined by the claims that follow.

We claim:

1. A reconfigurable optical communication system, comprising:
an Ethernet switch having multiple input and output channels, wherein the Ethernet switch is configured to direct a data stream received over each of the input channels to one of the output channels based on data extracted from the data stream;
an optical transceiver coupled to the Ethernet switch and configured to generate a multiplexed optical signal from signals received from the output channels of the Ethernet switch; and
an optical unit coupled to the optical transceiver to receive the multiplexed optical signal and configured to drop a wavelength channel.

2. The reconfigurable optical communication system according to claim 1, wherein the data stream comprises data packets with headers and the data extracted from the data stream comprise VLAN tags that are stored in the headers of the data packets.

3. The reconfigurable optical communication system according to claim 1, further comprising additional optical units coupled in series with said optical unit, wherein each of the additional optical units is configured to drop a different wavelength channel.

4. The reconfigurable optical communication system according to claim 3, wherein the additional optical units include a first additional optical unit and a second additional optical unit, and the first additional optical unit is positioned to receive a first multiplexed optical signal from said optical unit coupled to the optical transceiver and the second additional optical unit is positioned to receive a second multiplexed optical signal from the first additional optical unit.

5. The reconfigurable optical communication system according to claim 4, wherein the first multiplexed optical signal does not include the wavelength channel separated out by said optical unit coupled to the optical transceiver, and the second multiplexed optical signal does not include the wavelength channel separated out by said optical unit coupled to the optical transceiver and the wavelength channel separated out by the first additional optical unit.

6. The reconfigurable optical communication system according to claim 4, wherein the first additional optical unit is further configured to add a wavelength channel and the second multiplexed signal includes the wavelength channel added by the first additional optical unit.

7. The reconfigurable optical communication system according to claim 6, wherein the second additional optical unit is further configured to add a wavelength channel to the second multiplexed signal received from the first additional optical unit.

8. In an optical network having a first node and a second node, a method for routing an Ethernet-based data stream to one of the first node and the second node, the method comprising the steps of:
receiving multiple data streams of Ethernet packets through input channels of an Ethernet switch, the multiple data streams including at least a first data stream and a second data stream;
directing the first data stream to a first output channel of the Ethernet switch based on data contained in the first data stream;
directing the second data stream to a second output channel of the Ethernet switch based on data contained in the second data stream;
generating a multiplexed optical signal that includes at least the first data stream in a first wavelength channel and the second data stream in a second wavelength channel; and
receiving the multiplexed optical signal at the first node and outputting one of the first and second data streams at the first node by dropping one of the first and second wavelength channels at the first node.

9. The method according to claim 8, further comprising the steps of:
receiving, at the second node, a multiplexed optical signal that does not include the wavelength channel dropped at the first node; and
outputting the other one of the first and second data streams at the second node by dropping the other one of the first and second wavelength channels at the second node.

10. The method according to claim 9, further comprising the step of transmitting a multiplexed optical signal that does not include the wavelength channels dropped at the first node and the second node to additional nodes of the optical network.

11. The method according to claim 9, further comprising the step of adding a wavelength channel to the multiplexed optical signal received at the second node.

12. The method according to claim 8, wherein each of the Ethernet packets comprises a VLAN tag and the VLAN tag is used by the Ethernet switch to selectively direct a data stream to an output channel of the Ethernet switch.

13. The method according to claim 12, wherein the Ethernet packets are Gigabit Ethernet packets.

14. The method according to claim 8, wherein the multiplexed optical signal is generated using an optical transceiver.

15. A method for generating a multiplexed optical signal from data streams of Ethernet packets, comprising the steps of:
examining header data of each Ethernet packet;
for each Ethernet packet examined, directing said each Ethernet packet to a first optical transceiver input channel if header data is of a first type and to a second optical transceiver input channel if header data is of a second type; and
multiplexing Ethernet packets received through optical transceiver input channels including the first optical transceiver input channel and the second optical transceiver input channel to generate a multiplexed optical signal,
wherein each of the optical transceiver input channels correspond to a different wavelength channel.

16. The method according to claim 15, wherein the steps of examining and directing are carried out in an Ethernet switch and the header data comprise VLAN tags.

17. The method according to claim 16, wherein the step of multiplexing is carried out in an optical transceiver that is coupled to the Ethernet switch to receive data streams therefrom.

18. The method according to claim 15, wherein the multiplexed optical signal contains multiple wavelength channels, and at least one of the multiple wavelength channels contains Ethernet packets from at least two different data streams of Ethernet packets.

19. The method according to claim 15, wherein the Ethernet packets are Gigabit Ethernet packets.

20. The method according to claim 15, further comprising the step of converting electrical signals that are received through the optical transceiver input channels to corresponding optical signals, prior to the step of multiplexing.
